(19) United States
(12) Patent Application Publication
(10) Pub. No.: US 2002/0195486 A1
(43) Pub. Date: Dec. 26, 2002

(54) System and method for rapidly and securely transferring funds electronically between two points

(76) Inventors: Guy F. Erb, San Antonio, TX (US); Kurt Thams, Santa Cruz, CA (US); Michael Casey, Carmel, CA (US); John Schick, San Francisco, CA (US)

Correspondence Address: Alan R. Thiele, A Professional Corporation, 3200 Fountain Place, 1445 Ross Avenue, Dallas, TX, 75202-2799, US

(21) Appl. No.: 10/227,705

(22) Filed: Aug. 26, 2002

Related U.S. Application Data
(63) Continuation of application No. 09/632,912, filed on Aug. 4, 2000.
(60) Provisional application No. 60/147,449, filed on Aug. 4, 1999.

(51) Int. Cl. G06F 17/60

(52) U.S. Cl. 235/379

(57) ABSTRACT

A system and method for rapidly and securely transferring funds electronically between two points comprises a server coupled to a network. The server contains software that receives an initiation funds transfer request from a first terminal via a network; generates a transaction number; stores the transaction number and data associated with the initiation funds transfer request in a memory location of the server; sends the transaction number to the first terminal via the network; receives a completion funds transfer request from a second terminal via the network; confirms that the completion funds transfer request is valid; updates the memory location to indicate that the funds transfer is complete; and sends a confirmation notice, which includes an amount of funds to dispense, to the second terminal via the network.

### CROSS-REFERENCE TO RELATED APPLICATION

This application is related to, and claims the benefit of, commonly assigned U.S. Provisional Application No. 60/147,449, entitled “System and Method for Rapidly and Securely Transferring Funds Electronically Between Two Points,” filed on Aug. 4, 1999. The subject matter of the related application is hereby incorporated by reference.

### BACKGROUND

1. Field of the Invention

This invention relates generally to money transfers, and more particularly to rapidly and securely transferring funds electronically between two points.

2. Description of the Background Art

Conventionally, in order to transfer money, a person (“sender”) wishing to send money electronically must first find a money transfer location. Upon arriving at the money transfer location, the sender fills out a form indicating the name of the recipient (and possibly further information) as well as the amount of money (“principal”) to be sent. The sender then delivers the form, along with the principal, and a “convenience” fee, to an agent at the money transfer location. The agent takes the information the form and enters it into a terminal, which uploads the information to a central server for later retrieval. Some money transfer firms avoid repeated forms by providing for a means to call up the personal data for frequent customers. Others do not use a central server, relying instead on communications by telephone and/or telecopier. The agent then hands a receipt to the sender confirming that the order to send money has been received. The total time necessary to complete the transfer can vary from two minutes to a half hour or more.

The person (the “recipient”) wishing to receive the money must then also find a money transfer location. Upon arrival at the location, the recipient fills out a second form indicating the recipient's name and other identifying data. The recipient then presents the form or a transaction number, with identification, to an agent at the receiving location. The agent verifies the identification of the recipient and then enters the information from the form or the transaction number into a terminal. The terminal accesses the central server and verifies that there was a send order for the principal indicated on the second form. Assuming that the recipient correctly filled out the form and that the transaction is verified, the agent then tenders the principal to the recipient. Some firms pay recipients in cash, others by check.

One of main inconveniences of this method is the time required of both the sender and the recipient, particularly if they must fill out forms each time they wish to send and receive money. If a sender wants to engage in multiple transactions, he or she may have to fill out multiple forms (one form for each transaction), even though his or her identification information has not changed between the time of filling out one form and the next. The same applies to a recipient. Each time the recipient receives a money order, the recipient may have to fill out a form. In any event, the transactions normally require a considerable amount cashier or clerk time at the Point-of-Sale, adding to the costs borne by the money transfer location.

Another problem with the above-mentioned method is that the sender or recipient may make errors when filling out their respective forms. This could lead to a delay in transferring the money by requiring the sender or recipient to fill out a new form to correct the information. The above systems are also susceptible to errors by cashiers and clerks.

Therefore, a new system and method for rapidly and securely transferring funds is needed.

### SUMMARY OF THE INVENTION

The present invention provides a system and method for rapidly and securely transferring funds between two locations, The system comprises at least two terminals for electronically sending and receiving funds coupled to a central server via telephone lines, the Internet, or any other data transmission system (for example, a satellite-based telecommunication system such as Globalstar). First, a sender acquires a transfer-card. The transfer-card can either be a prepaid card, like a prepaid calling card, or the transfer-card can simply be an identification card, like an ATM card which has the user's account number embedded in its memory. Regardless of the type of transfer-card, the card contains a card-identifying number or PIN.

Second, the sender presents the transfer-card, along with the principal and a transaction fee, to an agent at a transfer location. The agent swipes the card through a card-reader coupled to a terminal and specifies, by typing on a keyboard coupled to the terminal, the recipient's country and the amount to transfer. The agent enters his Agent ID along with his Agent PIN. Alternatively, if the card is prepaid, the sender, himself, may swipe the card through a card-reader coupled to the terminal. The sender then specifies the amount to transfer and the recipient's country.

RapidMoney software located in memory of the terminal then uploads the entered information along with the swiped card's identification (“ID”) number to RapidMoney software located in memory of a central server. The RapidMoney server software processes the request, stores the information, and calculates a currency conversion if the recipient's country is not the same as the sender's country. The RapidMoney server software then generates a transaction number and returns the transaction number to the sending terminal's RapidMoney software. The sender then gets a printed receipt including the transaction number, which verifies the transaction.

Next, the sender calls the recipient and gives him or her the transaction number as well as the ID number of the sender's transfer-card. The recipient then goes to a money transfer location and tells an agent both the transaction number and ID number and shows the agent a personal identification document. The agent then enters the information into a terminal. The terminal's RapidMoney software sends the information to the central server. The RapidMoney server software then searches for the transaction number in a database stored on the central server. If the ID number given by the recipient to the agent matches the ID number associated with the transaction number in the database, the agent gives the recipient the principal. The RapidMoney server software then indicates in the server's database that the transaction has been completed.

Other advantages and features of the present invention will be apparent from the drawings and detailed description as set forth below.

### BRIEF DESCRIPTION OF THE DRAWINGS

FIG. 1 is a block diagram of a server coupled to two terminals, for implementing the invention;

FIG. 2 is a block diagram showing contents of the server memory;

FIG. 3 is a block diagram showing contents of the terminal memory;

FIG. 4 is a flowchart of steps for performing a money transfer; and

FIG. 5 is a flowchart of an alternative method for performing the money transfer.

### DETAILED DESCRIPTION

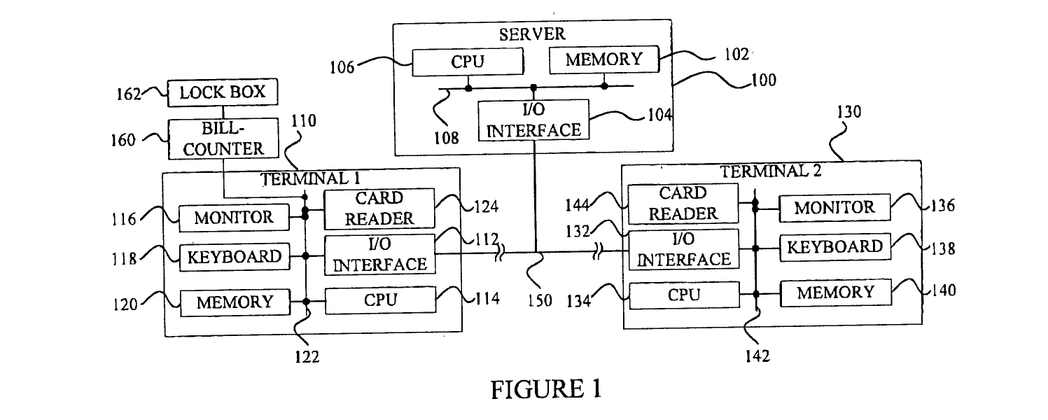

FIG. 1 is a block diagram of a server 100, suitable for implementing the invention, coupled to a terminal 110 and to a terminal 130. Server 100 includes at least one Central Processing Unit (CPU) 106, memory 102, and an input/output (I/O) interface 104, all connected by a system bus 108. I/O interface 104 connects server 100 to terminals 110 and 130 via a communications network 150, such as the Internet, thereby allowing server 100 to exchange data with terminal 110 and terminal 130. Network 150 is preferably impervious to eavesdropping and signal forgery. Server 100 can also be connected to terminals 110 and 130 via telephone lines and modems, or any other means for sending and receiving digital data. Memory 102 can be a single read and write capable memory device, or it may comprise multiple memory devices including a Hard Drive, RAM, ROM and/or any other memory devices. In addition, server 100 may also include a monitor, keyboard, or other peripheral devices (not shown).

Terminal 110 is a sending terminal and comprises I/O interface 112, CPU 114, monitor 116, keyboard 118, memory 120, and card reader 124, all connected by system bus 122. I/O interface 112 connects terminal 110 via network 150 to server 100, allowing server 100 and terminal 110 to exchange data. In an alternative embodiment, terminal 110 comprises a keypad or other data input device in place of card reader 124. Terminal 110 may also comprise other peripherals such as a mouse, trackball, microphone, etc. Terminal 110 can also be used as a receiving terminal as described below.

Terminal 130 is a receiving terminal and comprises the same devices as terminal 110 including I/O interface 132, CPU 134, monitor 136, keyboard 138, memory 140, and card reader 144, interconnected by system bus 142 I/O interface 132 connects terminal 130 via network 150 to server 100, 5 allowing server 100 and terminal 130 to exchange data. terminal 130 can also be used as a sending terminal.

Terminals 110 and 130 may also comprise a remote bill counter 160 coupled via system bus 122 or system bus 142 to one of the terminals. The remote bill counter 160 is a currency-scanning device, akin to those in soda vending machines. The remote bill counter 160 reads the value of the money that is passed through a scanner in the remote bill counter 160. The value of the bill(s) is then transmitted via network 150 to server 100. In addition, a tamper-proof lock box 162 may be coupled to the remote bill counter 160 to hold the scanned currency. The operators of terminals 110 and 130 cannot remove currency held in the lock box 162. Instead, the lock boxes are periodically collected by couriers and replaced with empty ones.

In an alternative embodiment, terminal 110 and/or terminal 130 are not coupled to server 100. Instead, data is communicated between a user and server 100 via telephone, fax or other conventional means. In another embodiment, terminals 110 and 130 are point of sale terminals.

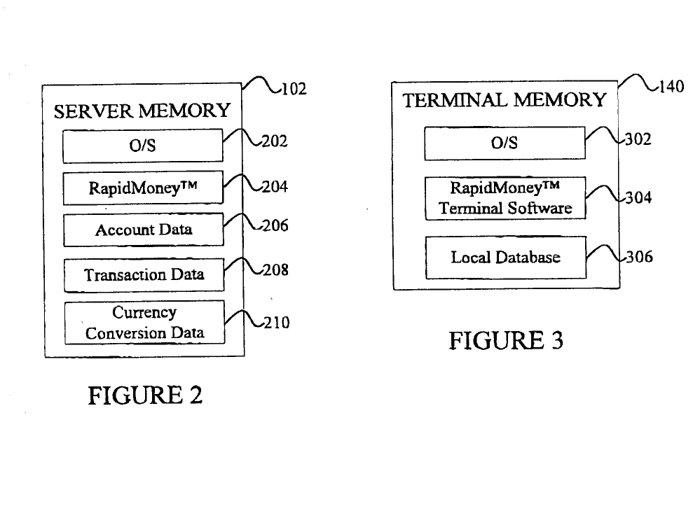

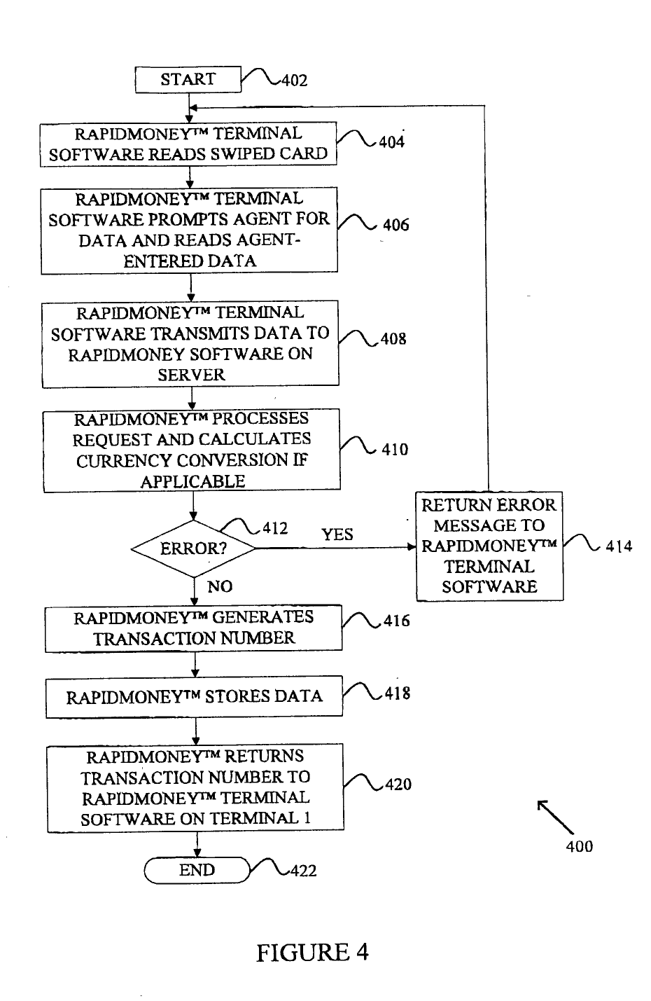

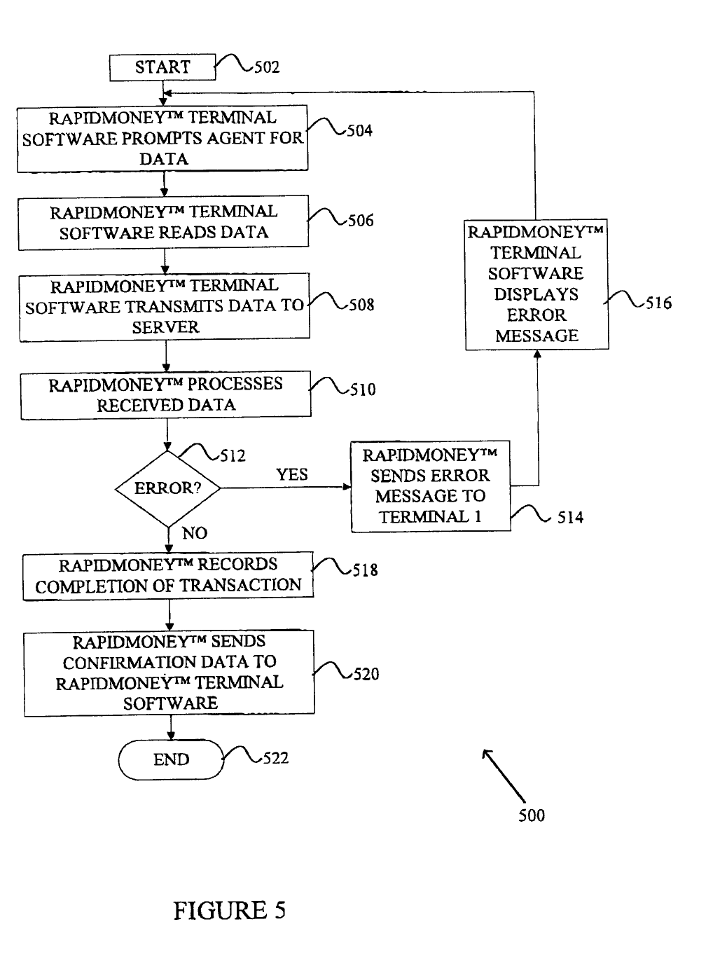

FIG. 2 is a block diagram showing contents of the server memory 102. Memory 102 holds RapidMoney™ software 204, which perform methods disclosed in FIGS. 4 and 5. Memory 102 also stores an operating system (“O/S”) 202 such as Windows NT®, Linux, or Solaris®, which is capable of executing the RapidMoney™ software 204. Also included in memory 102 are Account Data 206, Transaction Data 208, and Currency Conversion Data 210, which are accessed and modified by RapidMoney™ software 204 as will be described with reference to FIGS. 4 and 5. Currency Conversion Data 210 includes currency exchange rate data and can be modified regularly by an authorized administrator, or may be updated automatically based on current currency exchange rates by accessing currency tables available on the World Wide Web or other means.

FIG. 3 is a block diagram showing contents of the terminal memory 120 or 140. Memory 140 holds RapidMoney™ terminal software 304, which performs portions of the methods disclosed in FIGS. 4 and 5. Memory 140 also holds an operating system (O/S) 302, such as Windows® 98 or the operating system of Verifone® terminals, which is capable of executing RapidMoney™ terminal software 304. Local database 306, which also resides in memory 140, holds a machine identification (“ID”) and a vendor ID, which together constitute a pair of uniquely assigned numbers or alphanumeric characters. Both the machine ID and the vendor ID are pre-programmed into the local database and are transmitted with transaction data, as will be described below in conjunction with FIGS. 4 and 5.

FIG. 4 is a flowchart of steps according to the invention for initiating a money transfer process. Money can be transferred domestically or internationally At step 404, after an Agent swipes the sender's transfer-card through card-reader 124 (FIG. 1), RapidMoney terminal software 304 (FIG. 3) reads the data stored in a magnetic strip on the sender's transfer-card. A transfer-card is similar to a credit card in that it stores at least an account number in the magnetic strip on the card. The magnetic strip can also hold other data, such as the sender's name. The transfer-card can be purchased as a prepaid card. Alternatively, the transfer-card may be a smart card or other machine-readable or human-readable token.

At step 406, Rapidmoney™ terminal software 304 reads the data entered by the Agent, which includes the Agent's ID Number, which can be any combination of alphanumeric characters, and Personal Identification Number (“PIN”), the amount of money (including principal and transaction fee) collected from the sender, and the recipient's country. At step 408. RapidMoney™ terminal software 304 transmits the data read at steps 404 and 406 and the vendor ID and terminal (or “machine”) ID located in local database 306 of terminal 140 to RapidMoney™ software 204 located in memory 102 of server 100.

At step 410, RapidMoney™ server software 204 processes the received data by a) calculating a currency conversion, if the sender's and recipient's countries use different currencies, by using Currency Conversion Data 210; b) calculating the amount of money to be dispensed to the recipient (principal minus transaction fee); c) determining if the swiped transfer-card is valid; and d) determining if the Agent's ID number and PIN matches his ID number and PIN on record—If, at step 412, RapidMoney™ server software 204 determines that there is an error, i.e., the swiped transfer-card is invalid or the Agent's keyed ID number and PIN doesn't match his recorded ID number and PIN, etc., then method 400 proceeds to step 414, which returns an error message to RapidMoney™ Terminal Software 304 and returns to step 404.

If no error is detected at step 412, then at step 416 RapidMoney™ server software 204 generates a transaction number. At step 418 RapidMoney™ software 204 stores all the relevant data in Transaction Data 208 (which is located in server memory 102). Relevant data stored includes the transaction date and time (as determined by the server); the transaction number; the sender's transfer-card number; the Agent's ID number; the amount of money collected; the transaction fee; the exchange rate used; the amount of money collected in the sender's country's currency; and the amount of money to be dispensed in the recipient's country's currency.

At step 420 RapidMoney™ server software 204 returns the transaction number generated at step 416, as well as the data stored at step 418 (except for the sender's transfer-card number), to RapidMoney™ terminal software 304. Method 400 then ends at step 422.

In an alternative implementation of method 400, a sender purchases a prepaid transfer-card that holds a secret key. The secret key may be kept under a scratch-off mechanism on the surface of the transfer-card, or on a smart card or other suitable mechanism. One purpose for using a secret key is to ensure that the sender purchases an unused card. The sender then operates terminal 110 by himself or herself by swiping the prepaid transfer-card through card reader 124 (step 404) and specifying a destination country by entering it via keyboard 118. In place of step 406, the sender must also specify an amount to be transferred (up to the maximum value of the prepaid transfer card minus a transaction fee). Alternatively, RapidMoney™ terminal software 304 can automatically transfer the maximum value of the prepaid card minus a transaction fee. As no Agent is required, RapidMoney™ terminal software 304 does not prompt the sender for an Agent ID or pin. Method 400 then continues with step 408 except that it does not need to transmit the Agent ID or pin.

Once the operation is complete in FIG. 4, the sender contacts the recipient and tells him or her his transfer-card number and the transaction number. The recipient then presents this data to an Agent as disclosed below in conjunction with FIG. 5.

FIG. 5 is a flowchart of steps according to the invention for completing a money transfer process. At step 504 RapidMoney™ terminal software 304 prompts an Agent for data including the sender's transfer-card number, the transaction number, and the Agent ID and pin. The recipient provides the Agent with the sender's transfer-card number and transaction number, which are the same as those used in the sending process of FIG. 4. At step 506 RapidMoney™ terminal software 304 reads the data requested at step 504. At step 508 RapidMoney™ terminal software 304 transmits the collected data to RapidMoney™ software 204 on server 100 (FIG. 1). RapidMoney™ terminal software 304 also transmits the terminal's ID and vendor's ID to RapidMoney software 204 on server 100 (FIG. 1).

At step 510 RapidMoney™ software 204 processes the data, sent at step 508, by accessing account data 206 and transaction data 208 to verify that the sender's transfer-card number is valid and that the transaction is valid (i.e. the sender's transfer-card number is paired with the transaction number stored in transaction data 208) and has not been previously completed. At step 512, if RapidMoney™ software 204 determines that there is an error (i.e., the transaction is invalid), then at step 514 RapidMoney™ software 204 transmits an error message to RapidMoney™ terminal software 304. Then in step 516, RapidMoney™ terminal software 304 then displays the error message and returns to step 504.

If there is no error at step 512, then at step 518 RapidMoney™ software 204 records that the transaction is complete in transaction data 208. At step 520 RapidMoney™ software 204 sends a confirmation back to RapidMoney™ terminal software 304 confirming that the transaction is valid and complete. RapidMoney™ software 204 also sends the original data recorded at step 418 (FIG. 4), including the amount to be tendered by the Agent to the recipient.

The invention has been described above with reference to specific embodiments. It will, however, be evident that various modifications and changes may be made thereto without departing from the broader spirit and scope of the invention as set forth in the appended claims. The foregoing description and drawings are, accordingly, to be regarded in an illustrative rather than a restrictive sense.

What is claimed is:

1. A method for electronically transferring a value of funds from a first location to a second location, comprising:
receiving an initiation funds transfer request from a first terminal via a network;
generating a transaction number;
storing the transaction number and data associated with the initiation funds transfer request in a memory location of a server;
sending the transaction number via the network to the first terminal;
receiving a completion funds transfer request from a second terminal via the network;
confirming that the completion funds transfer request is valid;
sending a confirmation notice, which includes an amount of funds to dispense, via the network to the second terminal;
transferring the funds to the second terminal; and
updating the memory location to indicate that the funds transfer is complete.

2. The method of claim 1 wherein the network is the internet.

3. The method of claim 2 wherein the initiation funds transfer request comprises a transfer-card ID, a machine ID, an agency ID, an amount of money collected, and a recipient's country.

4. The method of claim 3 further comprising the steps of:
determining if a currency conversion calculation is required in order to complete the funds transfer; and calculating a currency conversion if required.

5. The method of claim 4 wherein the initiation funds transfer request further comprises an agent ID and an agent PIN.

6. The method of claim 5 wherein the step of confirming comprises determining if the transfer-card ID is valid and if the agent ID and agent PIN match records stored in the server.

7. The method of claim 6 wherein the completion funds transfer request comprises the transaction number and the transfer-card ID.

8. A computer-readable medium for storing instructions for enabling a computer to electronically transfer a value of funds from a first location to a second location, comprising:
receiving an initiation funds transfer request from a first terminal via a network;
generating a transaction number;
storing the transaction number and data associated with the initiation funds transfer request in a memory location of a server;
sending the transaction number via the network to the first terminal;
receiving a completion funds transfer request from a second terminal via the network;
confirming that the completion funds transfer request is valid;
sending a confirmation notice, which includes an amount of funds to dispense, via the network to the second terminal;
transferring the funds to the second terminal; and
updating the memory location to indicate that the funds transfer is complete.

9. The computer-readable medium of claim 8 wherein the network is the Internet.

10. The computer-readable medium of claim 9 wherein the initiation funds transfer request comprises a transfer-card ID, a machine ID, an agency ID, an amount of money collected, and a recipient's country.

11. The computer-readable medium of claim 10 further comprising:
determining if a currency conversion calculation is required in order to complete the funds transfer; and
calculating a currency conversion if required.

12. The computer-readable medium of claim 11 wherein the initiation funds transfer request further comprises an agent ID and an agent PIN.

13. The computer-readable medium of claim 11 wherein the step of confirming comprises determining if the transfer-card ID is valid and if the agent ID and agent PIN match records stored in the server.

14. The computer-readable medium of claim 13 wherein the completion funds transfer request comprises the transaction number and the transfer-card ID.

15. An electronic funds transfer system for transferring funds between a first and a second location, comprising:
a funds transfer module for
receiving an initiation funds transfer request from the first location via a network,
receiving a completion funds transfer request from the second location via the network, and
processing the funds transfer between the first location and the second location;
an account data module for storing account information for use in verifying that an initiation funds transfer request is valid;
a transaction data module for storing received initiation funds transfer requests and received completion funds transfer requests; and
a currency conversion data module for use in converting currencies when the first location and the second location use different currencies.

16. The electronic funds transfer system of claim 15 wherein the currency conversion data module is automatically updated on a predetermined basis by accessing currency tables on the Internet.

17. The electronic funds transfer system of claim 16 wherein the funds transfer module further stores transaction completion data in the transaction data module.

18. The electronic funds transfer system of claim 17 wherein the network is the Internet.
